(19) United States
(12) Patent Application Publication
(10) Pub. No.: US 2002/0084630 A1
(43) Pub. Date: Jul. 4, 2002

(54) Retaining device

(76) Inventor: Alexander Aulbach, Ulm (DE)

Correspondence Address: Michael D. Kaminski, FOLEY & LARDNER, Washington Harbour, 3000 K Street, N.W., Suite 500, Washington, DC, 20007-5143, US

(21) Appl. No.: 10/024,516

(22) Filed: Dec. 21, 2001

(30) Foreign Application Priority Data
Dec. 22, 2000 (DE) 100 65 795.8

(51) Int. Cl. B60R 21/16

(52) U.S. Cl. 280/728.2

(57) ABSTRACT

A retaining device for an airbag module is provided. At least a portion of the airbag module is connected to the retaining device. The retaining device may include a hook and an element for fastening the device to a motor vehicle component. The component may be, for example, a vehicle seat or a vehicle door. The element for fastening the device to the motor vehicle component may include an opening and fastener arrangement or a clip type arrangement.

### BACKGROUND

The invention relates to a retaining device for at least one structural element. In particular the invention relates to a retaining device for an airbag module.

Among other things, restraint systems for people in motor vehicles include side air bags. Side air bags are usually placed at different points along the longitudinal sides of the vehicle. Currently, there are a number of options for fitting the air bags to the vehicle. For example, the air bag may be integrated into a vehicle door or a vehicle seat. The side air bag may be integrated in the backrest of the seat, and can be fixed to a side strut of the backrest.

U.S. Pat. No. 5,752,714 (incorporated by reference herein) discloses an option for fastening an air bag to a vehicle backrest. In this, a carrier plate is welded to the round, rod-like strut of the backrest and the air-bag module is fastened on the said carrier plate.

The known method of fastening the carrier plate has several disadvantages. Costly and complicated welding engineering has to be used in order to install this carrier plate. Should a repair be needed, welding also is required during its removal. In addition, it is not possible to mount the air-bag module and carrier plate in one working step. First, the carrier plate has to be fastened to the seat and only then can the air-bag module be mounted on it.

If the side strut of the seat does not have a round rod shape and is instead designed as a flat metal plate, welding on the carrier plate and mounting of the air-bag module is even more difficult.

As a result of the drawbacks of existing arrangements, it is at least one object of the invention to provide a retaining device and a connecting arrangement by means of which a component, in particular an air bag or part of an air bag, can be fastened to a vehicle seat in a simple and cost-effective manner. In addition, a simple method for installing a structural element onto a motor-vehicle component is to be provided.

### SUMMARY OF THE INVENTION

According to an embodiment of the present invention, a retaining device for connecting an airbag module to a motor vehicle is provided. The retaining device includes means for fastening to a motor-vehicle component. These means may comprise at least one hook and at least one element for fastening to the component. The retaining device is connected to the motor-vehicle component via the fastening means.

According to the present invention, the structural element may be fastened in place on the retaining device before the retaining device is fitted into the vehicle. The preassembled unit of the structural element (e.g., air bag module) and retaining device can therefore be fastened to the motor-vehicle component in a simple manner in one working step. Should repair be needed, this unit can be removed easily and without special assisting means.

The hook is preferably hooked into a receiving opening of the motor-vehicle component. Installation is completed by fastening the retaining device to the component connection.

In an embodiment of the retaining device, the element for fastening to the component is an opening formed in the retaining device for receiving and for fitting a screw. The fitting of the device, like the removal, therefore proves to be very simple. However, the opening may also serve as a retainer for a clip by which the retaining device is clipped to the motor-vehicle component.

There is the option, furthermore, of designing the element for fastening to the component as a connecting part which is fastened on the retaining device. For example, as a clip or as a press-in rivet or press-in screw which is connected to a corresponding structure (screw, etc) of the motor-vehicle component. In this case, the connecting part is preferably of integral design with the retaining device.

The element for fastening the device to the component motor-vehicle component, is preferably situated in the edge region of the retaining device. This does away with the risk of the structural element, which is connected to the retaining device, protruding over the element and therefore obstructing the installation thereof on the motor-vehicle component.

The structural element (e.g., air bag module) which is to be connected to the retaining device or the structural element which is held by the retaining device is preferably connected to the said retaining device via a receiving opening. In this case, the retaining device preferably has a receiving region to which the structural element can be fastened in a simple manner. For example, an easily releasable screw connection. However, any means of connecting the structural element to the retaining device lies within the scope of the invention. It is essential only that the two parts can be connected to each other prior to being fitted to a motor-vehicle component.

The retaining device is preferably essentially of elongated design and is provided with angled portions. As a result, it can be matched to the shape of the motor-vehicle component. The receiving region of the structural element is preferably shaped in such a manner that there is space for receiving a screw connection, for example, between the structural element and retaining device. In addition, the deformation causes the rigidity of the device to be increased.

The production of the retaining device proves to be cost-effective if, preferably, the hook is of integral design with the retaining device. The preferred material for simple and cost-effective production is sheet metal. However, the retaining device may also be formed as a metal die casting or as a plastic injection molding with inserts. Castings and moldings are very cost-effective to produce. A further advantage of a plastic injection molded part resides in its low weight.

The embodiments described above are particularly suitable for installation on a vehicle seat, preferably on a strut of the backrest. However, the retaining device may be also installed onto a vehicle door, preferably onto a strut of the vehicle door. The structural element which is to be fastened into place is preferably a side air bag.

The scope of the invention includes fastening only a portion of an air bag or side air bag to the retaining device. For example a gas-sack-retaining ring, a diffuser, a gas sack and/or a gas generator may be connected the retaining ring. As a result, further elements of an air-bag restraint system may be integrated in other seat components, for example the side strut of the seat.

The retaining device according to the invention is preferably used for fastening an air bag to a motor-vehicle component, in particular to a vehicle seat or a vehicle door. The air bag may be mounted on the retaining device prior to being fitted. This unit (retaining device and air bag) can be fastened to the seat or to the door and also released with effortless ease and without special assisting means.

The invention furthermore provides a connecting arrangement having a retaining device according to the invention which additionally also includes the motor-vehicle component. In this case, the motor-vehicle component has at least one receiving opening into which the hook of the retaining device can be hooked.

A method according to the invention includes fastening a structural element to a retaining device by means of at least one hook and at least one element for connecting the device to the motor vehicle. The method further includes fastening the retaining device to the motor-vehicle component by fitting the hook into a receiving opening of the motor-vehicle component and screwing down the retaining device. This method provides simple, rapid and reversible installation.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a perspective view of a retaining device according to a first exemplary embodiment of the present invention,

FIG. 2 is a perspective view of a retaining device according to a second exemplary embodiment of the present invention,

FIG. 3 is a perspective view of a retaining device with a mounted gas-sack-retaining ring with a diffuser according to a third exemplary embodiment of the present invention,

FIG. 4 is a perspective view of a retaining device with a mounted gas-sack fastening with a diffuser according to a fourth exemplary embodiment of the present invention,

FIG. 5 is a perspective view a side strut of a backrest of a vehicle seat and a retaining device according to the present invention to be fastened thereto,

FIG. 6 is a perspective view of a retaining device according to a fifth exemplary embodiment of the present invention,

FIG. 7a is a bottom plan view of a retaining device according to a sixth exemplary embodiment of the present invention,

FIG. 7b is a side view of the retaining device of FIG. 7a,

FIG. 7c is a side view of the retaining device of FIG. 7a together with a covering cap,

FIG. 7d is a perspective view from above of the retaining device of FIG. 7a, and

FIG. 7e is a perspective view from above of the retaining device of FIG. 7a together with a covering cap.

FIG. 8 is a perspective view a side strut and a retaining device similar to the arrangement of FIG. 5, with the retaining device having a hook directed downwards.

### DETAILED DESCRIPTION

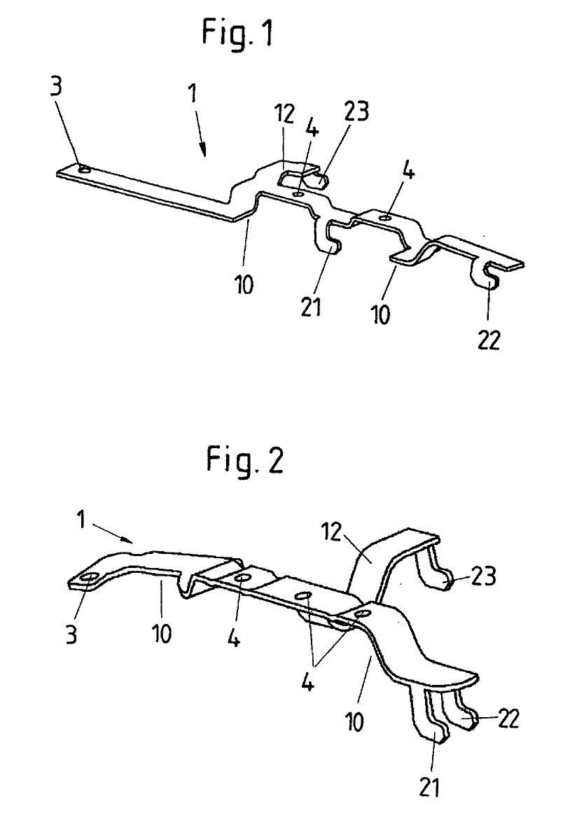

FIG. 1 discloses a first embodiment of a retaining device 1 according to the invention. The retaining device 1 is designed as an elongated metal plate and in addition to a plurality of angled regions has three hooks 21, 22, 23 for fitting into elongated holes (not illustrated) of a motor-vehicle component. A hook 23 may be formed on a side arm 12 of the retaining device 1.

An opening 3 which is formed in the edge region of the retaining device may be used in conjunction with the hooks 21, 22, 23 for fastening the device 1 to the motor-vehicle component by means of a screw connection or another method of fastening.

Furthermore, installation openings 4 are provided and can be used to fasten an air bag or another structural element to the retaining device 1, for example via a screw connection. Other methods of fastening may also be used.

FIG. 2 discloses a retaining device 1 which is similar to the exemplary embodiment of FIG. 1. The arrangement of the hooks 21, 22, 23 in the device of FIG. 2 differs from the hook arrangement shown in FIG. 1. Two hooks 21, 22 are arranged next to each other. The hook 23 may be situated on the small side arm 12 of the metal plate, the side arm 12 being curved and thereby providing a retainer in which, for example, a gas generator can be mounted. Installation openings 4 are provided in FIG. 2 for the fastening of a structural element.

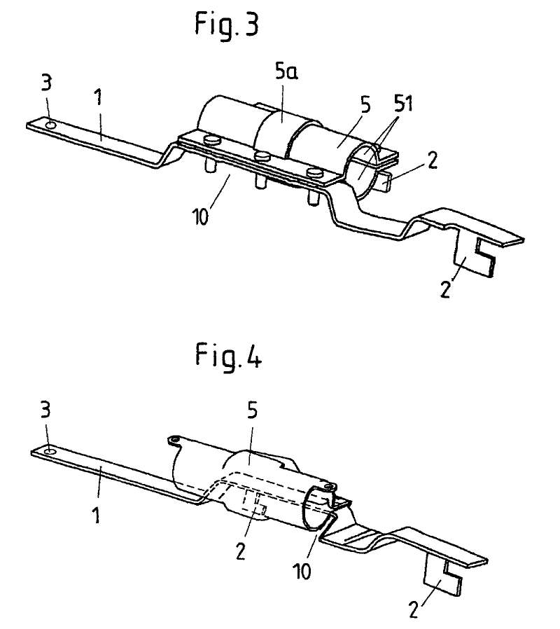

FIG. 3 illustrates a further retaining device 1 having two hooks 2. The retaining device 1 has a receiving region 10 in which a component 5 is fastened via screw connections or riveted connections. This receiving region 10 is of angled design.

The component may be an air bag retaining ring 5 with a diffuser which consists of two half shells 51. The air bag retaining ring 5 is used for securing the air bag, for receiving a gas generator and for directing the gas flow into a preferred discharging direction. Discharge openings (not illustrated) for the discharging gas are formed here in a central region 5a.

FIG. 4 illustrates a further refinement of an air bag retaining ring 5 (also referred to as a sleeve). In this case, the air bag is retained between the sleeve 5 and retaining plate 1. In addition, the sleeve 5 supports the gas generator and ensures that the gas flow is diverted into a preferred discharge direction. In this case, slots (not illustrated) are provided in the sleeve for the purpose of appropriately discharging the gas if triggered.

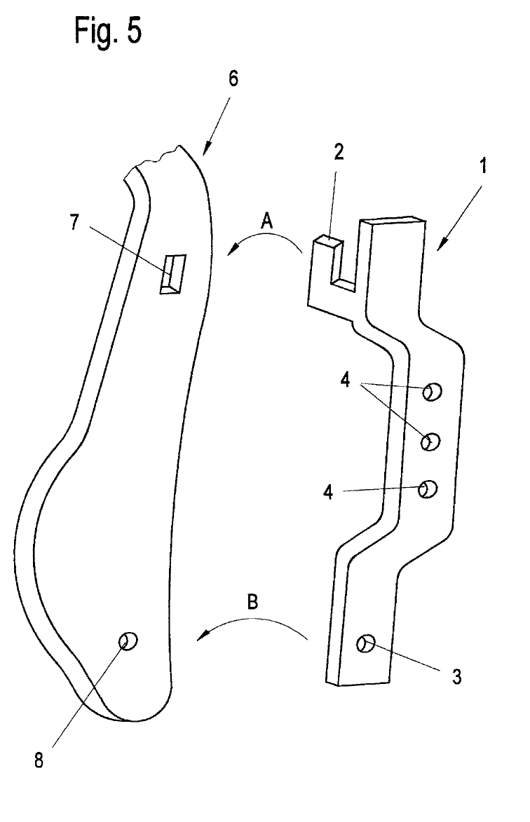

FIG. 5 shows a side strut 6 of the backrest of a vehicle seat next to a retaining device 1. The side strut 6 has an opening 8 and a receiving opening 7. These openings correspond in accordance with the arrows A, B to the opening 3 and the hook 2 of the retaining device 1. The retaining device 1 contains in turn additional installation openings 4 for the fastening of a structural element.

Following the installation of a side air bag, the retaining device can be fastened to the side strut or to the struting arrangement of the vehicle door. For this purpose, the hook 2 is inserted into the receiving opening 7 (provided for it) of the side strut 6. The retaining device 1 is then locked to the side strut 6 via the corresponding openings 3, 8 by means of a screw connection or another method of fastening.

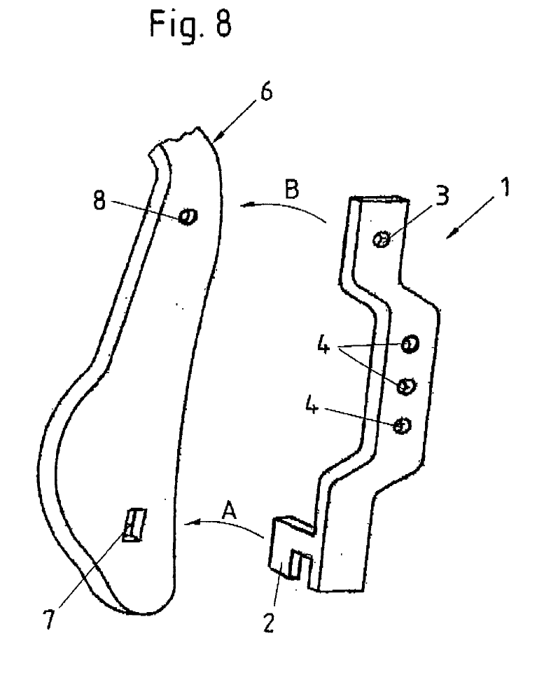

FIG. 8 shows an embodiment similar to the embodiment of FIG. 5. However, in FIG. 8, the retaining device is arranged so that the hook 2 is pointed or directed downwards (i.e. towards the floor of the vehicle) when the retaining device 1 is secured to the side strut 6. The hook 2 is inserted into the receiving opening 7 along arrow A in FIG. 8. Afterwards, the retaining device 1 is locked to the side strut 6 via corresponding openings 3, 8 by means of a screw connection or another method of fastening.

The securing of the retaining device 1 to the side strut 6 with the downwardly pointing hook 2 has the advantage that there is no danger that the retaining device 1 may drop off in case of shock and vibrations and if the screw connection or another fastening of openings 3, 8 becomes loose. A further advantage is that assembly of the retaining device 1 is simplified as the hook 2 rests against the receiving opening 7 of side the side strut 7 during assembly holding the retaining device 1 in position during fastening.

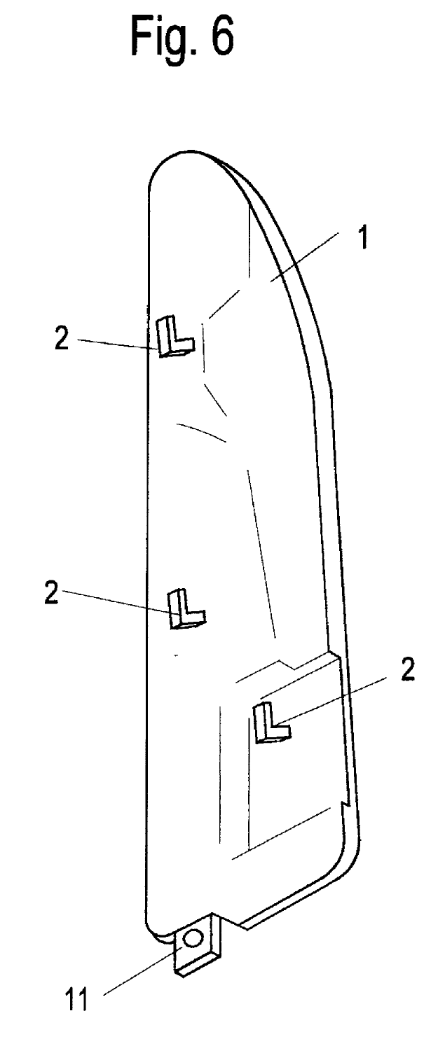

The retaining device may have any desired shape. In particular, the device may be formed as a planar sheet-metal element 1. A correspondingly designed retaining device is illustrated in FIG. 6. Three hooks 2 are arranged in the sheet-metal element 1. An opening 3 for the screwing to a side strut 6 is formed on an extension 11 of the sheet-metal element 1.

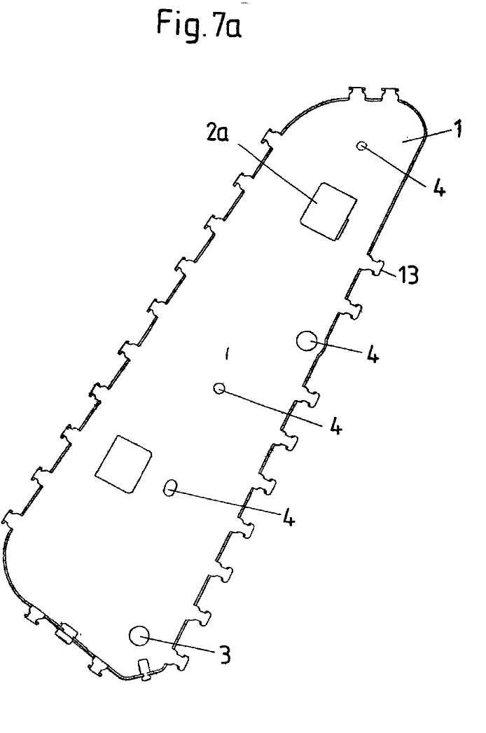

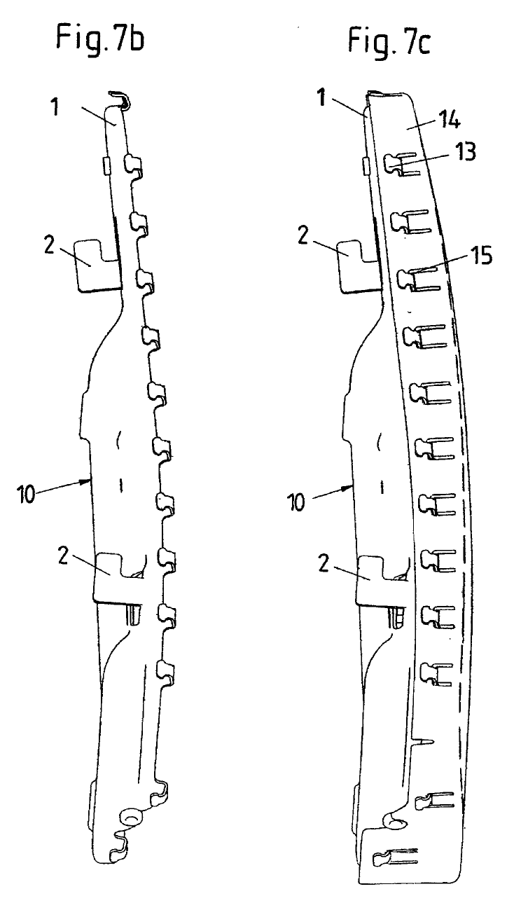

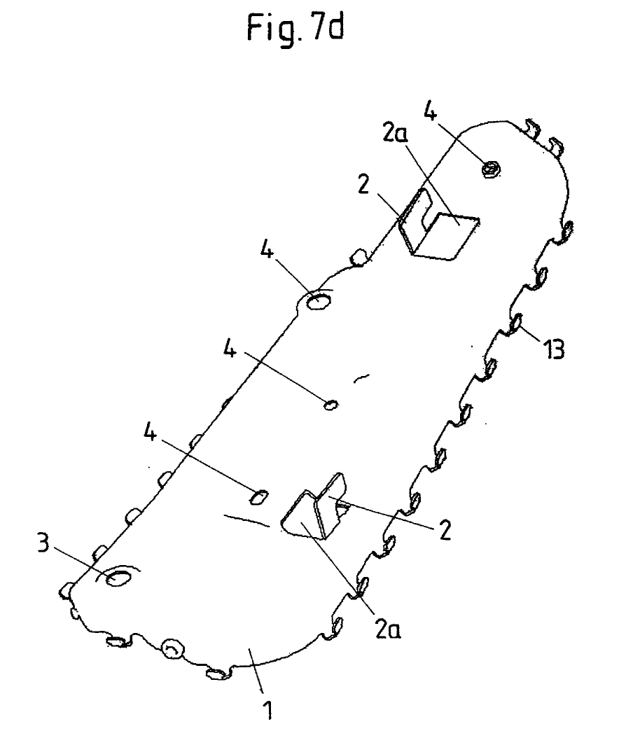

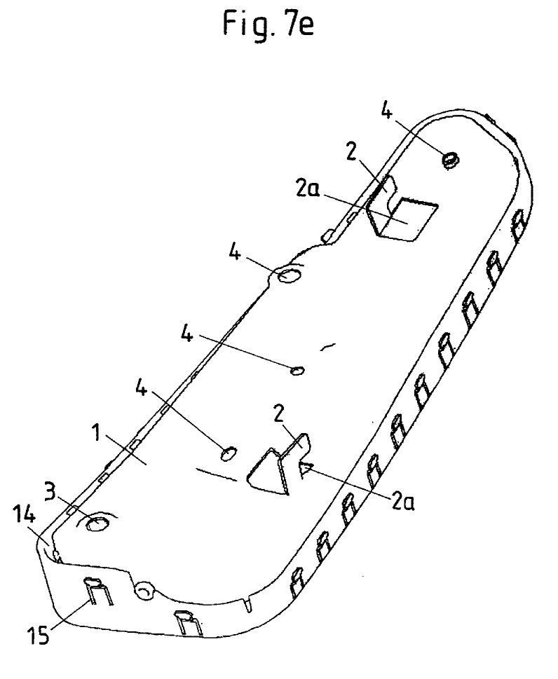

FIGS. 7a to 7e illustrate a further retaining device which is designed as a planar element 1. It has, in the edge region, an opening 3 for fastening to a motor-vehicle component and two hooks 2 which are each arranged on the edge of an essentially square punched opening 2a. A plurality of installation openings 4 are situated in a receiving region 10 which is angled in the direction of the motor-vehicle component and serves for the fastening of an air-bag module or part of an air-bag module to the retaining device.

In addition, the device 1 has peripheral hook elements 13. The hook elements 13 are angled in the direction of the motor-vehicle component and are used for fastening a covering cap 14 to the retaining device. The covering cap corresponds in its shape to the device 1 and has openings 15 in an angled edge region on its periphery. In the exemplary embodiment illustrated, the openings 15 are in each case formed from slots arranged in a U-shape. The slots correspond to the hook elements 13. The covering cap 14 sits on that side of the device 1 which faces away from the motor-vehicle component.

After an air-bag module or part of an air-bag module has been fastened to the receiving section 10 the covering cap 14 is fixed in place to form the covering. In this case, both steps may take place prior to the installation of the retaining device. The retaining device may then be connected to a motor-vehicle component via the hooks 2 and the opening 3.

The invention is not restricted to the exemplary embodiments illustrated above. One feature for the invention is for a retaining device for at least one structural element which is connected to the retaining device to have means for fastening to a motor-vehicle component, the said means comprising at least one hook and at least one element for fastening to the motor-vehicle component.

Germany Priority Application 100 65 795.8, filed Dec. 22, 2000 including the specification, drawings, claims and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A retaining device for an air bag module comprising:
a receiving region adapted to be connected to at least a portion of an air-bag module;
at least one hook adapted to engage a component of a motor vehicle;
an element to be fastened to the component.

2. The retaining device of claim 1, wherein the hook is configured to be hooked into a receiving opening of the motor-vehicle component.

3. The retaining device of claim 2, wherein the element comprises an opening for receiving a fastening device.

4. The retaining device of claim 3, wherein the fastening device comprises one of a screw or a clip.

5. The retaining device of claim 2, wherein the element comprises one of a press-in rivet or a clip.

6. The retaining device of claim 1, wherein the element is positioned in an edge region of the retaining device and thereby avoids being obstructed by the at least a portion of the air-bag module.

7. The retaining device of claim 1, wherein the receiving region includes at least one opening via which the at least part of the air-bag module can be fastened to the retaining device.

8. The retaining device of claim 1, wherein the retaining device is elongated.

9. The retaining device of claim 1, wherein the retaining device includes angled portions.

10. The retaining device of claim 1, wherein the receiving region is angled.

11. The retaining device of claim 1, wherein the hook is integrally connected to the retaining device.

11. The retaining device of claim 1, wherein the retaining device comprises sheet metal.

12. The retaining device of claim 1, wherein the retaining device is formed as a metal die casting.

13. The retaining device of claim 1, wherein the retaining device is plastic formed by injection molding.

14. The retaining device of claim 1, wherein the motor-vehicle component is a vehicle seat.

15. The retaining device of claim 13, wherein the retaining device is adapted to be fastened to a side strut of a backrest of the vehicle seat.

16. The retaining device of claim 1, wherein the motor-vehicle component is a vehicle door.

17. The retaining device of claim 14, wherein the retaining device is adapted to be fastened to a strut of the vehicle door.

18. The retaining device of claim 1, wherein the portion of the airbag module includes at least one of an air bag retaining element, a gas-generator retaining element, or a covering cap of an air bag.

19. A system for connecting an airbag module to a motor vehicle comprising:
a retaining device connected to at least a portion of the air-bag module and a component of the motor vehicle,
wherein the retaining device has at least one hook and at least one element for connecting to the component;
wherein the component of the motor vehicle includes at least one receiving opening so that the retaining device can be hooked into the receiving opening by means of the hook and can be connected to the component of the motor vehicle via the element.

20. The system of claim 19, wherein the component of the motor vehicle is a backrest of a vehicle seat.

21. The system of claim 19, wherein the component of the motor vehicle is a strut of a vehicle door.

22. The system of claim 19, wherein the receiving opening is an elongated hole.

23. The system according to claim 19, wherein the hook of the retaining device connected to the component of the motor vehicle includes an open end directed toward to a floor of the motor vehicle.

24. A method for installing an air-bag module on a motor vehicle component, comprising the steps of:
a) fastening the component to a retaining device having at least one hook and at least one element for connecting the device to the motor vehicle component,
b) mounting the retaining device on the motor vehicle component by fitting the hook into a receiving opening of the motor vehicle component and fastening the retaining device to the motor vehicle component using the element.
